(19) United States
(12) Patent Application Publication
(10) Pub. No.: US 2012/0235457 A1
(43) Pub. Date: Sep. 20, 2012

(54) METHOD AND APPARATUS FOR SWIVEL DEVICE

(76) Inventor: Joseph N. Laurita, Wayne, NJ (US)

(21) Appl. No.: 13/483,396

(22) Filed: May 30, 2012

(51) Int. Cl. A47C 7/02; B23P 11/02; B23P 11/00

(52) U.S. Cl. 297/344.21; 29/428; 29/446

(57) ABSTRACT

An apparatus comprising a chair, a first section, and a second section. The chair may be configured to be detachably fixed to the first section. The first section may be configured to pivot with respect to the second section. The chair may have first and second members; the first section may have a first and second clips; and the first and second members of the chair may be configured to be simultaneously detachably fixed to the first and second clips. The chair may be a folding chair. The first section may include a circular disk. The second section may include a circular disk. The circular disk of the first section may be fixed with respect to the circular disk of the second section so that the circular disk of the first section rotates with respect to the circular disk of the second section.

### FIELD OF THE INVENTION

This invention relates to improved methods and apparatus concerning swivel devices.

### BACKGROUND OF THE INVENTION

There are various devices known in the prior art for swivel devices.

### SUMMARY OF THE INVENTION

One or more embodiments of the present invention provide an apparatus comprising a chair, a first section, and a second section. The chair may be configured to be detachably fixed to the first section. The first section may be configured to pivot with respect to the second section. The chair may have a first member; the first section may have a first clip; and the first member of the chair may be configured to be detachably fixed to the first clip.

The chair may have a second member which is spaced apart from the first member. The first section may have a second clip. The second member of the chair may be configured to be detachably fixed to the second clip while the first member is detachably fixed to the first clip. The chair may be a folding chair. The first section may include a circular disk. The second section may include a circular disk. The circular disk of the first section may be fixed with respect to the circular disk of the second section so that the circular disk of the first section rotates with respect to the circular disk of the second section. A plurality of balls may be located between the circular disk of the first section and the circular disk of the second section.

The apparatus may also include a third section, wherein the second section is fixed to the third section. The third section may include a top member and a plurality of posts which are substantially perpendicular to the top member. The third section may include first and second members which are substantially perpendicular to the plurality of posts and which are substantially parallel to the top member. The third section may include third and fourth members which are substantially parallel to the top member and which are substantially perpendicular to the plurality of posts and to the first and the second members. The first section may include first and second elongated members to which the chair can be detachably fixed. The first and second elongated members may be parallel to each other.

A method may be further provided including attaching a chair to a first section, so that the chair can be detached from the first section, wherein the first section is fixed to a second section so that the first section is configured to pivot with respect to the second section. Components previously specified for an apparatus may be provided for implementation of a method in one or more embodiments of the present invention.

### BRIEF DESCRIPTION OF THE DRAWINGS

FIG. 1A shows a front, right side, top perspective view of a swivel apparatus in accordance with an embodiment of the present invention, with the swivel apparatus in an assembled state;

FIG. 1B shows a rear, left side, top perspective view of the swivel apparatus of FIG. 1A, with the swivel apparatus in an assembled state;

FIG. 2A shows a front, right side, top perspective view of the swivel apparatus of FIG. 1A, with the swivel apparatus in a taken apart state;

FIG. 2B shows a rear, left side, top perspective view of the swivel apparatus of FIG. 1A, with the swivel apparatus in a taken apart state;

FIG. 3 shows a cross sectional view of a portion of the swivel apparatus of FIG. 1A; and

FIG. 4 shows a front, right side, top perspective view of the swivel apparatus of FIG. 1A in an assembled state with a chair attached to the swivel apparatus of FIG. 1A in accordance with an embodiment of the present invention.

### DETAILED DESCRIPTION OF THE DRAWINGS

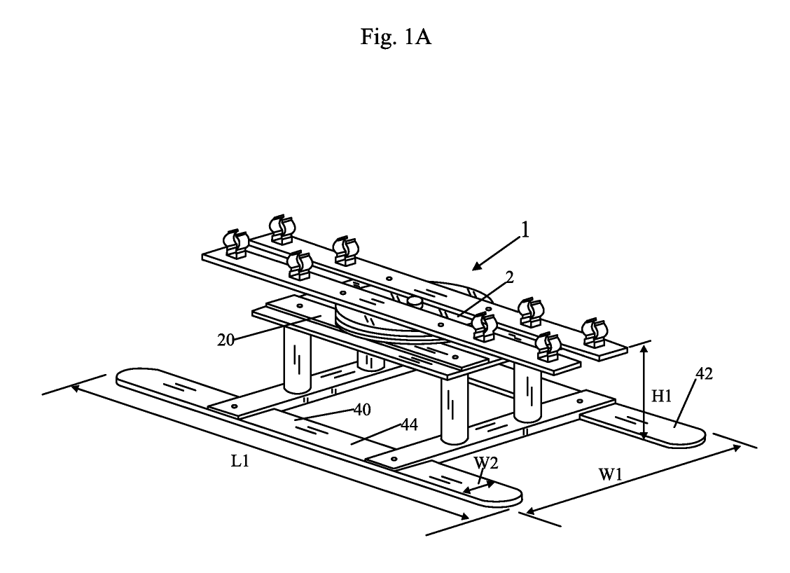

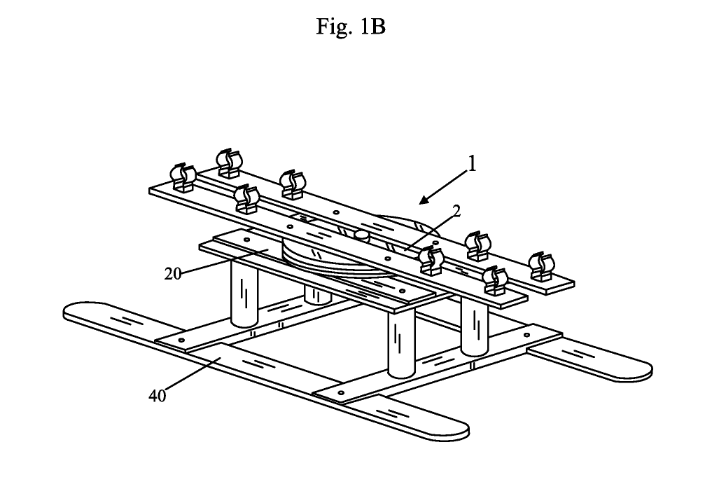

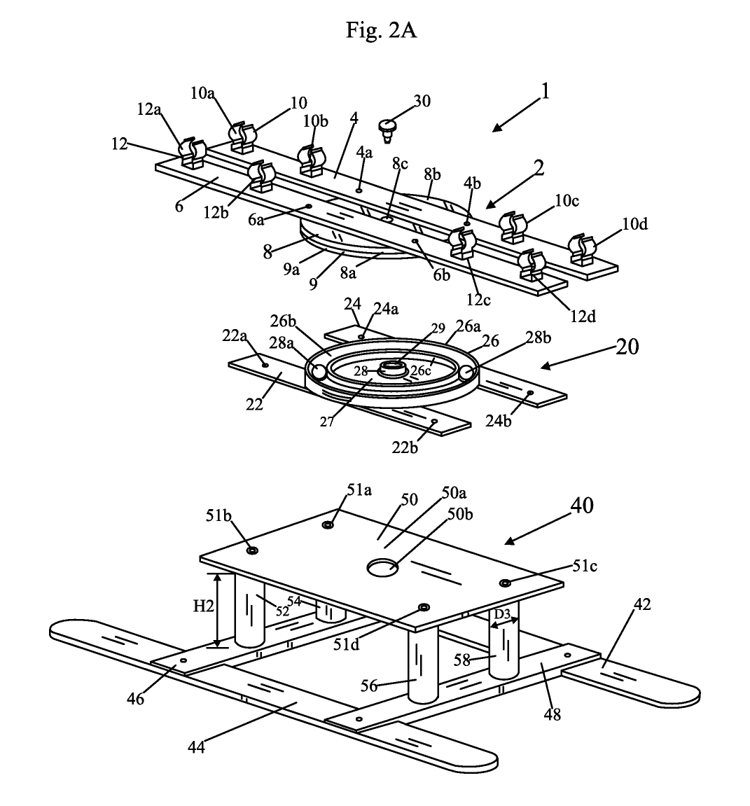

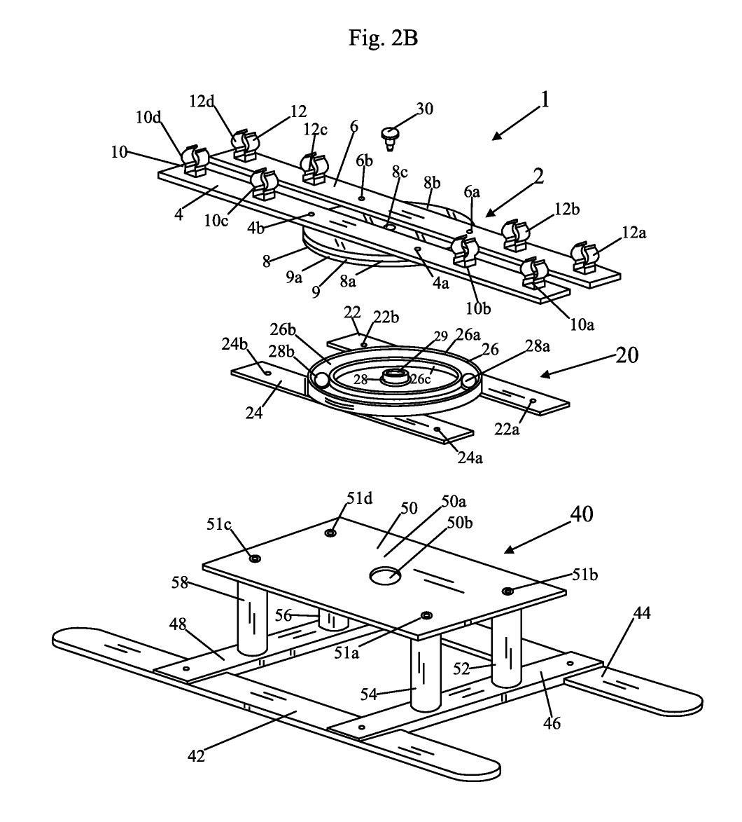

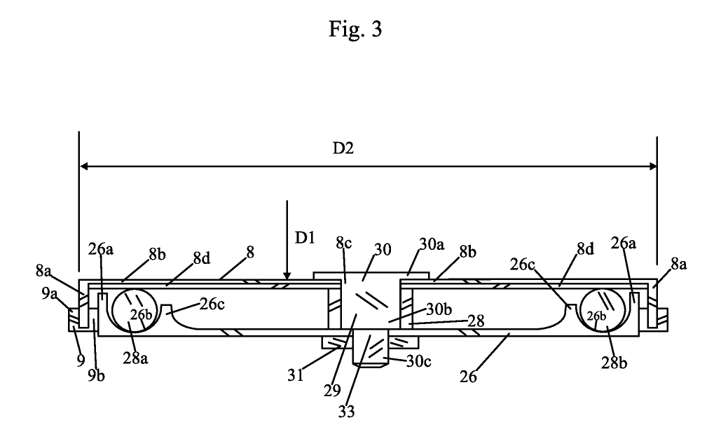

FIG. 1A shows a front, right side, top perspective view of a swivel apparatus 1 in accordance with an embodiment of the present invention, with the swivel apparatus 1 in an assembled state. FIG. 1B shows a rear, left side, top perspective view of the swivel apparatus 1 of FIG. 1A, with the swivel apparatus 1 in an assembled state. FIG. 2A shows a front, right side, top perspective view of the swivel apparatus 1 of FIG. 1A, with the swivel apparatus 1 in a taken apart state. FIG. 2B shows a rear, left side, top perspective view of the swivel apparatus 1 of FIG. 1A, with the swivel apparatus 1 in a taken apart state. FIG. 3 shows a cross sectional view of a portion of the swivel apparatus 1 of FIG. 1A.

Referring to FIGS. 2A-2B, the swivel apparatus 1 includes sections 2, 20, and 40. The section 2 includes members 4 and 6. The section 2 further includes circular disk or member 8.

A plurality 10 of clips are fixed to the member 4 and a plurality 12 of clips are fixed to the member 6. Each of the members 4 and 6 may be a solid rigid beam, such as a solid wood or solid metal beam or plank. The plurality 10 of clips include clips 10a, 10b, 10c, and 10d; and the plurality 12 of clips include clips 12a, 12b, 12c, and 12d. The member 4 has openings and/or fasteners 4a and 4b through which the member 4 is fixed to the circular disk or member 8. The member 6 has openings and/or fasteners 6a and 6b through which the member 6 is fixed to the circular disk or member 8.

The circular disk or member 8 may be made of a solid rigid material such as wood or metal. The circular disk or member 8 may have a periphery 8a, a top surface 8b, and a central opening 8c. A rubber seal 9 having a peripheral surface 9a may be fixed to the periphery 8a, such as by an adhesive.

The section 20 includes members 24 and 22, and a circular member 26. The circular member 26 is fixed to the members 24 and 22. The member 24 includes openings 24a and 24b; and the member 26 includes openings 22a and 22b. The circular member 26 has a peripheral wall 26a, an inner wall 26c, and a curved surface 26b between the peripheral wall 26a and the inner wall 26c. Balls 28a and 28b lie on the curved surface 26b and can roll on the curved surface 26b around the inner wall 26c, and between the inner wall 26c and the peripheral wall 26a. The circular member 26 also includes a central support sleeve 28 having an opening 29. The support sleeve 28 is fixed to the surface 27 and the opening 29 runs through the surface 27.

The section 40 includes members 42, 44, 46, and 48. The member 42 may be fixed to the member 48 at a right angle or substantially at a right angle; the member 42 may be fixed to the member 46 at a right angle or substantially at a right angle; The member 44 may be fixed to the member 48 at a right angle or substantially at a right angle; and the member 44 may be fixed to the member 46 at a right angle or substantially at a right angle. Each of the members 42, 44, 46, and 48 may be made of a rigid material such as wood or metal.

The section 40 may include supports or posts 52, 54, 56, and 58. The supports or posts 52, 54, 56, and 58 may be made of a rigid material such as wood or metal. Each of the supports or posts 52 and 54 may be at a right angle with respect to the member 46; and each of the supports or posts 56 and 58 may be at a right angle with respect to the member 48.

The section 40 may include a top member or table top 50. The top member 50 may have a top surface 50a and a central opening 50b. The top member 50 may be fixed to the posts 52, 54, 56, and 58 by or through fasteners and/or openings 51a, 51b, 51c, and 51d.

The section 20 may be fixed to the section 40 by fixing the members 22 and 24 to the table top member 50 by aligning openings or fasteners 22a and 51b, 24a, and 51a, 22b and 51d, and 24b and 51c, and aligning opening 29 with opening 50b, at the same time. Fasteners may be used to fix the section 20 to the section 40 through openings 22a and 51b, 24a and 51a, 22b and 51d, and 24b and 51c.

The section 2 can be placed on top of the section 20 by placing the circular disk or member 8 over the circular disk or member 26 as shown by FIGS. 1A and 1B, and FIG. 3. As shown by FIG. 3, the circular disk 8 has been placed so that the peripheral wall 8a surrounds the peripheral wall 26a. The outer wall 9a of the seal 9 is shown in FIG. 3, and an inner wall 9b of the seal 9 between the peripheral wall 8a and the peripheral wall 26a is also shown. The seal 9 prevents material or debris from getting between the circular disk or member 8 and the circular disk or member 26.

As also shown in FIG. 3, the circular disk or member 8 includes an inner seal material 8d below the surface 8b. The balls 28a and 28b are shown in FIG. 3 fitting in the curved surface 26b between the wall 26a and the wall 26c. The inner seal material 8d rides on the balls 28a and 28b. The inner seal material 8d does not directly contact the wall 26a. The circular disk or member 8 can pivot or rotate about a pivot pin 30. The pivot pin 30 includes portions 30a, 30b, and 30c. The pivot pin 30 is held in place by a lock nut 31 shown in FIG. 3. The portion 30a prevents the pin 30 from falling through the opening 8c of the circular member 8. The portion 30b lies in opening 8c and in a central bore or opening 29 of the sleeve 28, and the portion 30c partly lies in an opening 33 in the disk 26, and in a central opening of the lock nut 31. In this manner the circular disk 8 may be pivotally fixed to the circular disk 26 to allow rotation about pivot pin 30.

As shown in FIG. 1A, the apparatus 1, when assembled, may have a length L1, which may be approximately thirty six inches, a width, W1, which may be approximately twenty-four inches, and a height H1 (not including height of clips 10 and 12), which may be approximately eight and three quarters inches.

The posts 52, 54, 56, and 58 may be made of aluminum. The members 42, 44, 46, and 48 may be made of wood. The inner seal material 8d may be made of plastic and may be a plastic liner. The seal 9 may be a plastic or rubber seal material which allows the circular disk 8 to rotate freely with respect to the circular disk 26. The circular disks or member 8 and 26 may be made of aluminum. Each of the balls 28a and 28b may be made of solid nylon and may have a one inch diameter. The arrangement shown in FIG. 3, may be designed in at least one embodiment to support four to five hundred pounds placed on top of circular member 8, so that circular member 8 can freely rotate with respect to the circular member 26 with the four to five hundred pounds pushing down in the direction D1 on the top surface 8b.

The circular disk 8 may have a diameter of D2, shown in FIG. 3, which may be approximately twelve inches. Each of the members 42 and 44, shown in FIG. 1A, may have a width W2, which may be about four inches. Each of the posts 52, 54, 56, and 58 may be a solid cylinder and may have a diameter D3 which may be about two inches, and a height H2 which may be about six inches as shown in FIG. 2A.

The circular disk 8, the circular disk 26, the member 4, the member 6, the member 24, the member 26, the top member 50, and the posts 52, 54, 56, and 58 may be made of aluminum.

Balls 28a and 28b are typically identical. Although only balls 28a and 28b are shown, typically there would be thirty to sixty balls, each identical to ball 28a or ball 28b, and each placed between walls 26a and 26c, and on the curved surface 26b, and would sit between the circular disk 8 and the circular disk 26.

The apparatus 1 can be used as a base for any product requiring a three hundred and sixty degree swivel action. The apparatus 1 has a top swivel assembly including brackets or clips 10 and 12 to accommodate existing bench and lawn chairs. The clips 10 and 12 shown will hold and locate the specific chair being used.

The apparatus 1 can be made in different sizes, and other changes can be done to to accommodate weights and mounting requirements. The configuration shown in FIGS. 1A-3 (amount of parts) can be changed to reduce production costs and total assembly weight. The apparatus 1 can be made to be portable or stationary.

Typically, the apparatus 1 is portable with the chair or chairs being attached at a final location. In at least one embodiment, the apparatus 1 will be light in weight to allow easy transportation.

The apparatus 1 also allows cleaning of sand (from beach) or any similar type materials or debris to prevent swivel function from being disturbed.

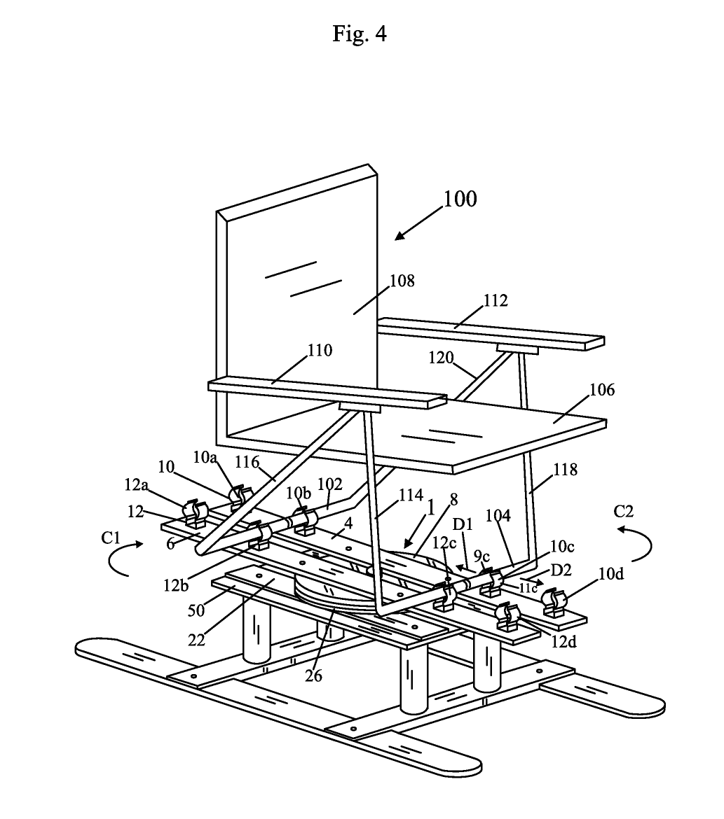

FIG. 4 shows a front, right side, top perspective view of the swivel apparatus 1 of FIG. 1A in an assembled state with a chair 100 attached to the swivel apparatus 1 of FIG. 1A in accordance with an embodiment of the present invention.

The chair 100 includes a seat 106, a seat backing or back 108, arms 110, and 112, legs 114, 116, 118, and 120, and horizontal members 102 and 104. The chair 100 may be a folding chair as known in the art. The horizontal member 102 may be inserted into the clips 10b and 12b while at the same time the horizontal member 104 is inserted into the clips 10c and 12c. The horizontal members 102 and 104 push portions of the clips into which they are inserted apart and then are inserted into the clips. For example, member 104 pushes portion 9c in the direction D1 while at the same time pushing portion 11c in the direction D2 in order to pry the portions 9c and 11c of the clip 10c apart and allow the member 104 to be inserted into clip 10c. A space or gap between the portions 9c and 11c of the clip 10c may be smaller or more narrow than the diameter or width of the member 104 so that the member 104 is held in place by the clip 10c unless the portions 9c and 11c are again pried apart to loosen the member 104 from the clip 10c. The members 102 and 104 may be inserted into and held by any of the clips 10 or clips 12 in a similar or the same manner.

FIG. 4 shows the chair 100 inserted into and held by clips 10b, 12b, 11c, and 12c, but the apparatus 1 can accommodate other size chairs, such as chairs that would be held by clip 10a, 12a, and 10d and 12d, for example.

With the chair 100 attached to the apparatus 1, as shown in FIG. 4, the chair 100, along with the circular disk 8 to which the chair 100 is attached through members 4 and 6, can rotate in a clockwise direction C1 or in a counterclockwise direction C2 with respect to the circular disk 26 which is fixed to the table top 50 through members 22 and 24.

The apparatus 1 shown in FIGS. 1-4 can be modified in accordance with one or more embodiments of the present invention. In some embodiments, the number of parts can be reduced to reduce costs. In some embodiments, different materials may be used and/or different assembly methods. Sizes may be changed or reduced to reduce weights. Various parts may be combined together by molding methods. One or more parts may be replaced for assembly and for improved functional reasons. In one or more embodiments, the size and components used to accommodate products to be used with swivel assembly may be longer and heavier.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a chair;
a first section; and
a second section;
wherein the chair is configured to be detachably fixed to the first section;
and wherein the first section is configured to pivot with respect to the second section.

2. The apparatus of claim 1 wherein
the chair has a first member;
the first section has a first clip; and
wherein the first member of the chair is configured to be detachably fixed to the first clip.

3. The apparatus of claim 2 wherein
the chair has a second member which is spaced apart from the first member;
the first section has a second clip; and
wherein the second member of the chair is configured to be detachably fixed to the second clip while the first member is detachably fixed to the first clip.

4. The apparatus of claim 1 wherein
the chair is a folding chair.

5. The apparatus of claim 1 wherein
the first section includes a circular disk;
and the second section includes a circular disk;
and wherein the circular disk of the first section is fixed with respect to the circular disk of the second section so that the circular disk of the first section rotates with respect to the circular disk of the second section.

6. The apparatus of claim 5 further comprising
a plurality of balls located between the circular disk of the first section and the circular disk of the second section.

7. The apparatus of claim 1 further comprising
a third section;
and wherein the second section is fixed to the third section.

8. The apparatus of claim 7 wherein
the third section includes a top member and a plurality of posts which are substantially perpendicular to the top member.

9. The apparatus of claim 8 wherein
the third section includes first and second members which are substantially perpendicular to the plurality of posts and which are substantially parallel to the top member;
wherein the third section includes third and fourth members which are substantially parallel to the top member and which are substantially perpendicular to the plurality of posts and to the first and the second members.

10. The apparatus of claim 1 wherein
the first section includes first and second elongated members to which the chair can be detachably fixed;
and wherein the first and second elongated members are parallel to each other.

11. A method comprising
attaching a chair to a first section, so that the chair can be detached from the first section;
wherein the first section is fixed to a second section so that the first section is configured to pivot with respect to the second section.

12. The method of claim 11 wherein
the chair has a first member;
the first section has a first clip; and
wherein the first member of the chair is configured to be detachably fixed to the first clip.

13. The method of claim 12 wherein
the chair has a second member which is spaced apart from the first member;
the first section has a second clip; and
wherein the second member of the chair is configured to be detachably fixed to the second clip while the first member is detachably fixed to the first clip.

14. The method of claim 11 wherein
the chair is a folding chair.

15. The method of claim 11 wherein
the first section includes a circular disk;
and the second section includes a circular disk;
and wherein the circular disk of the first section is fixed with respect to the circular disk of the second section so that the circular disk of the first section rotates with respect to the circular disk of the second section.

16. The method of claim 15 wherein
there are a plurality of balls located between the circular disk of the first section and the circular disk of the second section.

17. The method of claim 11 wherein
and wherein the second section is fixed to a third section.

18. The method of claim 17 wherein
the third section includes a top member and a plurality of posts which are substantially perpendicular to the top member.

19. The method of claim 18 wherein
the third section includes first and second members which are substantially perpendicular to the plurality of posts and which are substantially parallel to the top member;
wherein the third section includes third and fourth members which are substantially parallel to the top member and which are substantially perpendicular to the plurality of posts and to the first and the second members.

20. The method of claim 11 wherein
the first section includes first and second elongated members to which the chair can be detachably fixed;
and wherein the first and second elongated members are parallel to each other.
